(19) United States
(12) Patent Application Publication
(10) Pub. No.: US 2026/0018325 A1
(43) Pub. Date: Jan. 15, 2026

(54) PLANAR TRANSFORM COMPONENT AND PLANAR TRANSFORM DEVICE

(71) Applicant: Ace Power and Technology Co.,Ltd, Shanghai (CN)

(72) Inventor: Yuetian WANG, Shanghai (CN)

(73) Assignee: Ace Power and Technology Co.,Ltd, Shanghai (CN)

(21) Appl. No.: 18/992,995

(22) PCT Filed: Apr. 26, 2023
(86) PCT No.: PCT/CN2023/090722

§ 371 Date: Jan. 10, 2025

(30) Foreign Application Priority Data
Jul. 11, 2022 (CN) 202210811824.1

(51) Int. Cl. H01F 27/28; H01F 27/34

(52) U.S. Cl. CPC H01F 27/2804; H01F 27/346; H01F 2027/2809; H01F 2027/2819

(57) ABSTRACT

The present disclosure provides a planar transform component and a planar transform device. The planar transform component includes a winding body including a primary winding and a secondary winding; a primary wiring electrically connected to the primary winding and led out from a first side of the winding body; and a secondary wiring electrically connected to the secondary winding and led out from a second side of the winding body. An extension direction of the secondary wiring is provided at an included angle with a direction from the first side to the third side. The present disclosure can reduce alternating current loss and leakage inductance loss.

### CROSS-REFERENCE TO RELATED DISCLOSURE

This disclosure claims priority to Chinese Patent Disclosure No. 202210811824.1, filed in the Chinese Patent Office on Jul. 11, 2022 and entitled “PLANAR TRANSFORM COMPONENT AND PLANAR TRANSFORM DEVICEDEVICE”, which is incorporated herein by reference in its entirety.

### TECHNICAL FIELD

The present disclosure relates to the technical field of transforms, and more particularly, to a planar transform component and a planar transform device.

### BACKGROUND

With development of electronic devices, the electronic devices have increasingly high requirements for power density on supply adapt components. Currently, a planar transform component is usually applied for improving the power density of the supply adapt component. A conventional planar transform component includes two types. For one, a coil plate is not integrated with other devices to provide a simple manufacturing process; a thickness of copper on a surface of a coil is not limited and may be thicker, and the thicker the thickness of the copper on the coil, the less the impedance of the coil; thereby improving power transmission efficiency of the planar transform component. For another one, the coil plate is integrated with other devices and other coil plates, and a line connecting a secondary-side coil and a rectifying device may be very short, thereby greatly reducing alternating current loss and leakage inductance loss.

### Technical Problem

In a case that the coil plate is not integrated with other devices and other coil plates, the line connecting the secondary-side coil and the rectifying device on the circuit board is relatively long, which increases an area of an uncoupled area and impedance and therefore causes relatively serious alternating current loss and leakage inductance loss during operation.

In a case that the coil plate is integrated with other devices and other coil plates, the manufacturing process is complicated and a spacing between pins of an integrated device is small. Due to the small spacing between pins of the integrated device, the thickness of the copper on the surface of the coil plate generally may not exceed 2OZ.

### Technical Solution

In order to improve the disadvantages of the prior art, it is an object of the present disclosure to provide a planar transform component and a planar transform device for solving the problems of large loss of alternating current and leakage inductance in the conventional planar transform component.

To achieve the above object, the present disclosure provides a planar transform component including:
a winding body, where the winding body includes a primary winding and a secondary winding stacked, where a first side, a second side, and a third side are provided along a circumference of the winding body, and the first side and the third side are oppositely disposed;
a primary wiring, where the primary wiring is electrically connected to the primary winding, and the primary wiring is led out from the first side of the winding body; and
a secondary wiring, where the secondary wiring is electrically connected to the secondary winding, the secondary wiring is led out from the second side of the winding body, and an extension direction of the secondary wiring is provided at an included angle with a direction from the first side to the third side.

In some embodiments of the present disclosure, the included angle defined by the extension direction of the secondary wiring and the direction from the first side to the third side ranges from 0° to 180°.

In some embodiments of the present disclosure, the winding body is a multi-layer structure of a plurality of PCB boards.

In some embodiments of the present disclosure, the plurality of PCB boards is stacked in a stacking direction of the primary winding and the secondary winding.

In some embodiments of the present disclosure, PCB boards of the plurality of PCB boards in the primary winding are disposed adjacent to each other, and PCB boards of the plurality of PCB boards in the secondary winding are disposed adjacent to each other.

In some embodiments of the present disclosure, PCB boards of the plurality of PCB boards in the primary winding and PCB boards of the plurality of PCB boards in the secondary winding are alternatively stacked with each other.

In some embodiments of the present disclosure, PCB boards of the plurality of PCB boards in the primary winding are provided in a middle of the winding body, and PCB boards of the plurality of PCB boards in the secondary winding are stacked on opposite sides of the primary winding in a first direction.

In some embodiments of the present disclosure, the secondary wiring includes a first secondary sub-wiring and a second secondary sub-wiring; the first secondary sub-wiring and the second secondary sub-wiring are led out from the second side of the winding body, respectively; the first secondary sub-wiring and the second secondary sub-wiring are electrically connected to both ends of the secondary winding, respectively; an extension direction of the first secondary sub-wiring is provided at an included angle with the direction from the first side to the third side, and an extension direction of the second secondary sub-wiring is provided at an included angle with the direction from the first side to the third side.

In some embodiments of the present disclosure, the extension direction of the first secondary sub-wiring and the extension direction of the second secondary sub-wiring are arranged in parallel; and the first secondary sub-wiring and the second secondary sub-wiring partially overlap in a stacking direction of the primary winding and the secondary winding.

In some embodiments of the present disclosure, the first secondary sub-wiring and the second secondary sub-wiring completely overlap in the stacking direction of the primary winding and the secondary winding.

In some embodiments of the present disclosure, the planar transform component includes a magnetic core having a magnetic column, the primary winding and the secondary winding are wound around the magnetic column, respectively;
the magnetic core further includes an outer frame around the winding body, a groove for receiving the winding body is defined in the outer frame, and the magnetic column is connected to the outer frame and positioned in the groove; and
a first opening and a second opening are provided on a side wall of the groove of the outer frame, the first opening is provided corresponding to the first side of the winding body for the primary wiring passing through, the second opening is provided corresponding to the second side of the winding body for the secondary wiring passing through, and the first opening and the second opening are respectively communicated with the groove.

In some embodiments of the present disclosure, a third opening is provided on the side wall of the groove, and the third opening communicates with the groove.

In some embodiments of the present disclosure, ta plurality of third openings is provided on the side wall of the groove.

In some embodiments of the present disclosure, a fourth opening is provided on the side wall of the groove, the winding body includes a fourth side, the fourth side is provided opposite to the second side, the fourth opening is provided corresponding to the fourth side, and the fourth opening communicates with the groove.

In some embodiments of the present disclosure, the outer frame includes a spacer between the first opening and the second opening of the outer frame, the spacer is disposed outside the winding body, and a first insulating member is provided between the spacer and the primary wiring.

In some embodiments of the present disclosure, the outer frame includes a spacer between the first opening and the second opening of the outer frame, the spacer is disposed outside the winding body, and a second insulating member is provided between the spacer and the secondary wiring.

Accordingly, the present disclosure also provides a planar transform including: a circuit board;
the planar transform as above, where the primary wiring and secondary wiring of the planar transform component are electrically connected to the circuit board, respectively, and the second side of the winding body faces the circuit board.

In some embodiments of the present disclosure, the circuit board includes a first connecting portion and a second connecting portion, the primary wiring is electrically connected to the first connecting portion, the secondary wiring is electrically connected to the second connecting portion, and a creepage distance predetermined between the first connecting portion and the second connecting portion.

In some embodiments of the present disclosure, the secondary wiring extends along a direction from the winding body toward the circuit board.

In some embodiments of the present disclosure, the creepage distance predetermined between the first connecting portion and the second connecting portion is obtained by providing a third insulating member between the spacer of the outer frame of the planar transform component and the circuit board to increase a creepage distance between the first connecting portion and the second connecting portion.

### Beneficial Effect

According to the planar transform component provided in the present disclosure, the primary wiring is arranged on the first side of the winding body, and the secondary wiring is arranged on the second side between the first side and the third side oppositely provided on the winding body. As such, the primary wiring and the secondary wiring are prevented from being led out from the two sides opposite to the winding body, and the leading-out direction of the primary wiring and the secondary wiring is arranged at an included angle. Therefore, during mounting the planar transform component with the circuit board, the wiring distance between the secondary wiring and the circuit board can be shortened, thereby reducing the alternating current loss and the leakage inductance loss.

### BRIEF DESCRIPTION OF THE DRAWINGS

In order that the technical solution in the embodiments of the present disclosure may be explained more clearly, reference will now be made to the accompanying drawings, which are intended to be used in the description of the embodiments. It should be understood that the accompanying drawings in the description below are merely some of the embodiments of the present disclosure, and other drawings may be obtained by those skilled in the art without involving any inventive effort.

FIG. 1 is a schematic structural diagram of a planar transform component according to an embodiment of the present disclosure;

FIG. 2 is a schematic structural diagram of a winding body, a primary wiring, and a secondary wiring according to an embodiment of the present disclosure;

FIG. 3 is a schematic structural diagram of a magnetic core according to an embodiment of the present disclosure;

FIG. 4 is a schematic structural diagram of another magnetic core according to an embodiment of the present disclosure;

FIG. 5 is a schematic structural diagram of yet another magnetic core according to an embodiment of the present disclosure;

FIG. 6 is a schematic structural diagram of a planar transform device according to an embodiment of the present disclosure; and

FIG. 7 is a schematic diagram of partially assembled components of a transform device according to an embodiment of the present disclosure.

### REFERENCE NUMERAL

| | | | |
|---|---|---|---|
| planar transform component | 1000 | magnetic core | 1100 |
| magnetic column | 1110 | outer frame | 1120 |
| winding body | 1200 | primary winding | 1210 |
| secondary winding | 1220 | first side | 1201 |
| second side | 1203 | third side | 1202 |
| primary wiring | 1300 | secondary wiring | 1400 |
| first secondary | 1401 | second secondary | 1402 |
| sub-wiring | | sub-wiring | |
| groove | 1121 | first opening | 1122 |
| second opening | 1123 | third opening | 1124 |
| fourth opening | 1125 | first insulating | 1500 |
| | | member | |
| second insulating | 1600 | planar transform | 2000 |
| member | | device | |
| circuit board | 2100 | first connecting | 2110 |
| | | portion | |
| second connecting | 2120 | third insulating | 2200 |
| portion | | member | |
| magnetic core | 1100a | magnetic core | 1100b |
| first opening | 1122a | first opening | 1122b |
| second opening | 1123a | second opening | 1123b |
| third opening | 1124a | spacer | 1126 |

### DETAILED DESCRIPTION OF THE EMBODIMENTS

In the following, the technical solutions in the embodiments of the present disclosure will be clearly and completely described in connection with the accompanying drawings in the embodiments of the present disclosure. It should be understood that the described embodiments are merely a part of the embodiments of the present disclosure, rather than all the embodiments. Based on the embodiments in the present disclosure, all other embodiments obtained by a person skilled in the art without involving any inventive effort are in the scope of the present disclosure.

Embodiments of the present disclosure provide a planar transform component and a planar transform device, which are described in detail below.

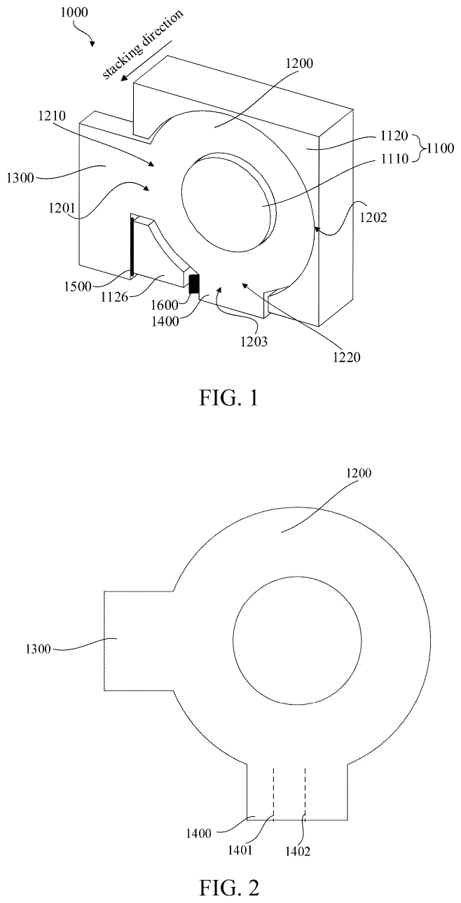

As shown in FIG. 1, embodiments of the present disclosure provide a planar transform component 1000 including a winding body 1200 for implementing a transform. The winding body 1200 includes a primary winding 1210 and a secondary winding 1220 stacked, while the winding body 1200 further includes a first side 1201, a second side 1203, and a third side 1202 arranged along a circumference of the winding body 1200, and the first side 1201 and the third side 1202 are oppositely disposed. The primary winding 1210 may serve as an input to the planar transform component 1000, the secondary winding 1220 may serve as an output to the planar transform component 1000, and a side of the output is typically used to connect loads. The primary winding 1210 and the secondary winding 1220 cooperate to effect a step-up or step-down conversion of the voltage on a side of the primary winding 1210 to the voltage on a side of the secondary winding 1220.

The planar transform component 1000 further includes a primary wiring 1300 and a secondary wiring 1400. The primary wiring 1300 is electrically connected to the primary winding 1210 and is led out from the first side 1201 of the winding body 1200. The secondary wiring 1400 is electrically connected to the secondary winding 1220, the secondary wiring 1400 is electrically connected to the secondary winding 1220 and is led out from the second side 1203 between the first side 1201 and the third side 1202 of the winding body 1200. The extension direction of the secondary wiring 1400 is provided at an included angle with the direction from the first side 1201 to the third side 1202. The primary wiring 1300 is led out from the first side 1201 of the winding body 1200 in order to minimize changes to the original structure of the conventional planar transform component 1000. The included angle between the extension direction of the secondary wiring 1400 and the direction from the first side 1201 to the third side 1202 ranges from 0° to 180°.

The secondary wiring 1400 and the primary wiring 1300 are prevented from being led out from opposite sides of the winding body 1200, and the secondary wiring 1400 is disposed between the opposite sides of the winding body 1200. As such, during mounting the planar transform component 1000 with the circuit board 2100, the wiring distance between the secondary wiring 1400 and the circuit board 2100 can be shortened, thereby reducing the length of the secondary wiring 1400. The shorter the length of the secondary wiring 1400, the smaller the influence of the skin effect and the proximity effect, the smaller the resistance of the secondary wiring 1400, and the smaller the alternating current loss.

At the same time, the direction of the magnetic flux of the first encircling region in the secondary winding 1220 is opposite to the direction of the magnetic flux of the second encircling region enclosed by the secondary wiring 1400, and the magnetic flux generated by the primary winding 1210 cannot all pass through the first encircling region of the secondary winding 1220. It should be understood that a portion of the magnetic flux generated by the primary winding 1210 causes a leakage inductance through the second encircling region in a direction opposite to the direction of the magnetic flux of the first encircling region, thereby causing a partial effect generated by the change of the magnetic flux of the first encircling region and the magnetic flux of the second encircling region to be offset. In the present disclosure, by shortening the length of the secondary wiring 1400, the area of the second encircling region formed by the secondary wiring 1400 can be reduced, thereby reducing the leakage inductance loss. Since the leakage inductance loss affects the alternating current loss, the leakage inductance loss is reduced while the alternating current loss is reduced.

According to the present disclosure, the primary wiring 1300 is provided on the first side 1201 of the winding body 1200, and the secondary wiring 1400 is provided on the second side 1203 between the first side 1201 and the third side 1202 opposite to the winding body 1200, so that the primary wiring 1300 and the secondary wiring 1400 are prevented from being led out from opposite sides of the winding body 1200, and the leading-out direction of the primary wiring 1300 and the leading-out direction of the secondary wiring 1400 is provided at an included angle. As such, during mounting the planar transform component 1000 with the circuit board 2100, the wiring distance between the secondary wiring 1400 and the circuit board 2100 can be shortened, thereby reducing the alternating current loss and the leakage inductance loss.

Specifically, the winding body 1200 may be a multi-layer structure of PCB boards, and the PCB boards are stacked in a stacking direction of the primary winding 1210 and the secondary winding 1220. The primary winding 1210 includes a plurality of PCB boards connected in series in sequence, an insulating material is provided between any adjacent PCB boards of the plurality of PCB boards, and each of the plurality of PCB boards is printed with a winding. The primary wiring 1300 is configured as the leading-out line connecting both ends of the PCB boards in series in the primary winding 1210. The secondary winding 1220 includes a plurality of PCB boards connected in series in sequence. The secondary wiring 1400 is configured as the leading-out line connecting both ends of the PCB boards connected in series in the secondary winding 1220. The PCB boards in the primary winding 1210 are different from the PCB boards in the secondary winding 1220.

In some embodiments, the plurality of PCB boards is disposed adjacent in primary winding 1210 and the plurality of PCB boards is disposed adjacent in secondary winding 1220.

In some embodiments, the plurality of PCB boards in the primary winding 1210 and the plurality of PCB boards in the secondary winding 1220 are alternatively stacked, thereby increasing the coupling of the primary winding 1210 and the secondary winding 1220 to reduce leakage inductance.

In some embodiments, to improve the heat dissipation effect of the planar transform component 1000, the plurality of PCB boards in the primary winding 1210 may be disposed in the middle of the winding body 1200, and the plurality of PCB boards in the secondary winding 1220 may be stacked on opposite sides of the primary winding 1210 in the first direction.

As shown in FIG. 2, the secondary wiring 1400 includes a first secondary sub-wiring 1401 and a second secondary sub-wiring 1402, which are led out from the second side 1203 of the winding body 1200. The first secondary sub-wiring 1401 and the second secondary sub-wiring 1402 are electrically connected to both ends of the secondary winding 1220, respectively. The extension direction of the first secondary sub-wiring 1401 is arranged at an included angle with the direction of the first side 1201 to the third side 1202. The extension direction of the second secondary sub-wiring 1402 is arranged at an included angle with the direction from the first side 1201 to the third side 1202. The included angle between the extension direction of the first sub-wiring 1401 and the direction from the first side 1201 to the third side 1202 ranges from 0° to 180°, and the included angle between the extension direction of the second sub-wiring 1402 and the direction from the first side 1201 to the third side 1202 is greater than 0°. It should be understood that the included angle is greater than 0° and less than 180°, which will not be described in detail below.

By arranging the first secondary sub-wiring 1401 and the second secondary sub-wiring 1402 led out from the second side 1203, the first secondary sub-wiring 1401 is disposed at an included angle with extension direction of the primary wiring 1300, while the second secondary sub-wiring 1402 is disposed at an included angle with the extension direction of the primary wiring 1300. As such, the length of the first secondary sub-wiring 1401 and the second secondary sub-wiring 1402 can be reduced while the secondary winding 1220 is electrically connected to the circuit board 2100, during mounting the planar transform component 1000 with the circuit board 2100. Thus, resistance of the first secondary sub-wiring 1401 and the second secondary sub-wiring 1402 is reduced, while reducing the area of the second encircling region enclosed by the first secondary sub-wiring 1401 and the second secondary sub-wiring 1402, thereby reducing the alternating current loss and the leakage inductance loss.

The first secondary sub-wiring 1401 and the second secondary sub-wiring 1402 are electrically connected to the two output ends of the secondary winding 1220, respectively. The effective area of the second encircling region enclosed by the first secondary sub-wiring 1401 and the second secondary sub-wiring 1402 may be the projection area in the stacking direction of the encircling region enclosed by the first secondary sub-wiring 1401 and the second secondary sub-wiring 1402. The extension direction of the first secondary sub-wiring 1401 has an included angle with the extension direction of the second secondary sub-wiring 1402.

In some embodiments, the first secondary sub-wiring 1401 may be perpendicular to the extension direction of the primary wiring 1300, and the second secondary sub-wiring 1402 is disposed at an included angle with the extension direction of the first sub-wiring 1401 and the extension direction of the primary wiring 1300, respectively. During mounting the planar transform component 1000 with the circuit board 2100, the planar transform component 1000 is vertically mounted to the circuit board 2100. On the one hand, the length of the first secondary sub-wiring 1401 and the second secondary sub-wiring 1402 can be reduced, and on the other hand, the effective area of the second encircling region enclosed by the first secondary sub-wiring 1401 and the second secondary sub-wiring 1402 can be reduced.

In some embodiments, the extension direction of the first secondary sub-wiring 1401 and the extension direction of the second secondary sub-wiring 1402 are arranged at an included angle, the extension direction of the first secondary sub-wiring 1401 and the extension direction of the primary wiring 1300 may be included at an included angle other than a right angle, and the extension direction of the second secondary sub-wiring 1402 and the extension direction of the primary wiring 1300 may be included at an included angle other than a right angle.

It should be noted that the extension direction of the first secondary sub-wiring 1401 or the extension direction of the second secondary sub-wiring 1402 may be the extension direction of the main wire of the first secondary sub-wiring 1401 or the extension direction of the main wire of the second secondary sub-wiring 1402, and should not be understood as the extension direction of the partially bent wire.

In some embodiments, the extension direction of the first secondary sub-wiring 1401 and the extension direction of the second secondary sub-wiring 1402 are arranged in parallel. The creepage distance between the first secondary sub-wiring 1401 and the second secondary sub-wiring 1402 is relatively stable by arranging the first secondary sub-wiring 1401 and the second secondary sub-wiring 1402 in parallel. Since the alternating current flows through the first secondary sub-wiring 1401 and the second secondary sub-wiring 1402 while the planar transform component 1000 is in operation, a magnetic field is generated around the changing current which causes the alternating current in the first secondary sub-wiring 1401 and the alternating current in the second secondary sub-wiring 1402 interferes with each other. By arranging the first secondary sub-wiring 1401 and the second secondary sub-wiring 1402 in parallel, the alternating current flowing through the first secondary sub-wiring 1401 and the second secondary sub-wiring 1402 is relatively stable, to avoid unnecessary inductance loss caused by the change of the distance between the first secondary sub-wiring 1401 and the second secondary sub-wiring 1402.

The extension direction of the first secondary sub-wiring 1401 and the extension direction of the second secondary sub-wiring 1402 are arranged at an included angle with the direction from the first side 1201 to the third side 1202, respectively.

In some embodiments, the extension direction of the first secondary sub-wiring 1401 and the extension direction of the second secondary sub-wiring 1402 are disposed perpendicular to the leading-out direction of the primary wiring 1300. As such, during mounting the planar transform component 1000 with the circuit board 2100, the length of the first secondary sub-wiring 1401 and the second secondary sub-wiring 1402 can be shortened as much as possible in a case that the second side 1203 of the winding body 1200 is opposed to the circuit board 2100. Meanwhile, the unnecessary inductance loss caused by the change in the distance between the first secondary sub-wiring 1401 and the second secondary sub-wiring 1402 can be avoided.

In some embodiments, both the extension direction of the first secondary sub-wiring 1401 and the extension direction of the second secondary sub-wiring 1402 are included at a non-right angle to the leading-out direction of the primary wiring 1300. For example, the extension direction of the first secondary sub-wiring 1401 and the extension direction of the second secondary sub-wiring 1402 may be away from the first side 1201 to increase the distance between the electrical connection of the primary wiring 1300 to the circuit board 2100 and the electrical connection of the first secondary sub-wiring 1401 to the circuit board 2100, and to increase the distance between the electrical connection of the primary wiring 1300 to the circuit board 2100 and the electrical connection of the second secondary sub-wiring 1402 to the circuit board 2100, thereby reducing the risk of electric leakage.

In some embodiments, the first secondary sub-wiring 1401 and the second secondary sub-wiring 1402 at least partially overlap in the stacking direction of the primary winding 1210 and the secondary winding 1220. Since the effective area of the second encircling region enclosed by the first secondary sub-wiring 1401 and the second secondary sub-wiring 1402 may be the projection area in the stacking direction of the encircling region enclosed by the first secondary sub-wiring 1401 and the second secondary sub-wiring 1402, the leakage inductance loss may be reduced by at least partially overlapping the first secondary sub-wiring 1401 and the second secondary sub-wiring 1402 in the stacking direction to reduce the effective area of the second encircling region as much as possible.

The first secondary sub-wiring 1401 and the second secondary sub-wiring 1402 may partially overlap or completely overlap in the stacking direction.

In some embodiments, the first secondary sub-wiring 1401 and the second secondary sub-wiring 1402 are sequentially arranged in the stacking direction, and the extension direction of the first secondary sub-wiring 1401 and the extension direction of the second secondary sub-wiring 1402 are arranged parallel to each other. At this time, the first secondary sub-wiring 1401 and the second secondary sub-wiring 1402 may be fully overlapped along the length direction of the magnetic column 1110 to minimize the effective area of the second enclosure region, thereby reducing the leakage inductance loss.

In some embodiments, the first secondary sub-wiring 1401 and the second secondary sub-wiring 1402 may partially overlap in the stacking direction, while reducing the effective area of the second encircling region to reduce leakage inductance loss

In some embodiments, the planar transform component 1000 includes a magnetic core 1100 having a magnetic column 1110, the primary winding 1210 and the secondary winding 1220 are wound on the magnetic column 1110, respectively. By providing the magnetic core 1100 to increase the density of the magnetic flux when the primary winding 1210 and the secondary winding 1220 mutual inductance, the primary winding 1210 and the secondary winding 1220 are wound around the magnetic column 1110, respectively, to reduce the leakage inductance loss.

The magnetic column 1110 may extend in the stacking direction. Specifically, the magnetic column 1110 extends in the stacking direction, and the primary winding 1210 and the secondary winding 1220 are wound around the magnetic column 1110 in the extending direction of the magnetic column 1110, respectively.

In some embodiment, the magnetic core 1100 further includes an outer frame 1120 for enclosing the winding body 1200, the outer frame 1120 is provided with a groove 1121 for receiving the winding body 1200, and the magnetic column 1110 is connected to the outer frame 1120 and is positioned in the groove 1121. The outer frame 1120 and the magnetic core 1100 cooperate with each other to increase the density of the magnetic flux when the primary winding and the secondary winding 1220 in mutual inductance, thereby improving the energy conversion efficiency. The outer frame 1120 and the magnetic column 1110 may be integrally formed to define the magnetic core 1100. The outer frame 1120 and the magnetic column 1110 may be of the same material.

After the winding body 1200 is mounted in the groove 1121, a side of the winding body 1200 away from the bottom of the groove 1121 is exposed for heat dissipation for the winding body 1200. During mounting the planar transform component 1000 with the circuit board 2100, the wiring distance between the secondary wiring 1400 and the circuit board 2100 is relatively short, and the effective area of the second encircling area encloses by the secondary wiring 1400 is relatively small.

Therefore, the winding body 1200 has little influence on the secondary wiring 1400, and even if the winding body 1200 is exposed on the side away from the bottom of the groove 1121, the winding body 1200 has little influence on the secondary wiring 1400.

In some embodiments, a cover plate may be provided to match the outer frame 1120 to define a closed magnetic circuit. The cover plate and the outer frame 1120 may be made of the same material. The cover plate, the outer frame 1120, and the magnetic column 1110 may be made of manganese-zinc ferrite, nickel-zinc ferrite, and the like. The cover plate, the outer frame 1120, and the magnetic column 1110 are sintered magnetic metal oxides composed of various iron oxide mixtures.

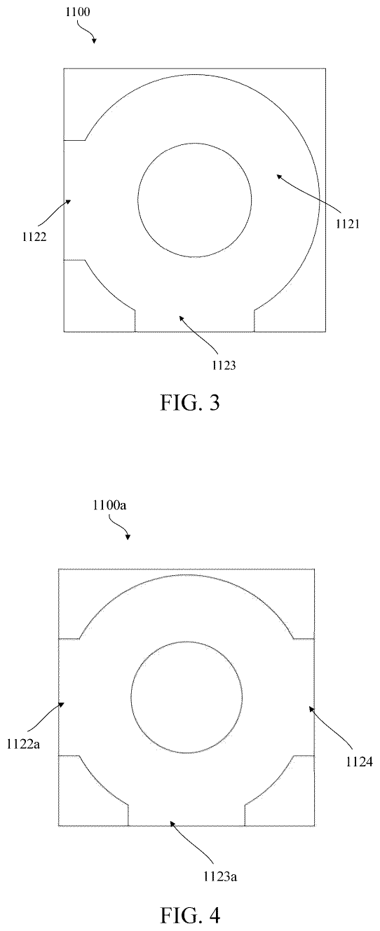

As shown in FIG. 3, the side wall of the groove 1121 of the outer frame 1120 is provided with a first opening 1122 and a second opening 1123, the first opening 1122 is provided in correspondence with the first side 1201 of the winding body 1200 for the primary wiring 1300 passing through, the second opening 1123 is provided in correspondence with the second side 1203 of the winding body 1200 for the secondary wiring 1400 passing through, and the first opening 1122 and the second opening 1123 communicate with the groove 1121, respectively. By providing the first opening 1122 and the second opening 1123 in the side wall of the groove 1121 of the outer frame 1120, the heat can be dissipated from the side of the winding body 1200 while the planar transform component 1000 is in operation, so that the temperature of the winding body 1200 is prevented from being excessively high in operation. At the same time, the positions of the primary wiring 1300 and the secondary wiring 1400 can be limited by providing the first opening 1122 and the second opening 1123, as such, the positions of the primary wiring 1300 and the secondary wiring 1400 are relatively fixed in the planar transform component 1000.

In some embodiments, opposing sides of the first opening 1122 abut the primary wiring 1300 to limit the primary wiring 1300; the opposite sides of the second opening 1123 abut the secondary wiring 1400 to limit the secondary wiring 1400.

In some embodiments, the width of the first opening 1122 may be slightly greater than the width of the portion of the primary wiring 1300 passing through, and the width of the second opening 1123 may be slightly greater than the width of the portion of the secondary wiring 1400 passing through, to increase the heat dissipation effect of the winding body 1200.

As shown in FIG. 4, the side wall of the groove 1121 is provided with at least one third opening 1124, which communicates with the groove 1121. At least one third opening 1124 is provided in the side wall of the groove 1121 to enhance the heat dissipation effect of the winding body 1200.

The number of the third openings 1124 provided in the side wall of the groove 1121 may be one or more. Specifically, when the number of the third openings 1124 is one or more, the first opening 1122 is configured for the primary wiring 1300 passing through, and the second opening is configured for the secondary wiring 1400 passing through. At this time, the third opening 1124 serves as the main opening for the heat dissipation along the circumference of the winding body 1200, thereby enhancing the heat dissipation effect of the winding body 1200. It should be understood that the number of third openings 1124 may be set according to the actual heat dissipation requirements of the winding body 1200.

As shown in FIG. 4, the third opening 1124 corresponds to the third side 1202 of the winding body 1200. By increasing the number of openings, the heat dissipation area of the winding body 1200 can be increased. At the same time, since the third opening 1124 and the first opening 1122a are arranged opposite to each other, during mounting the winding body 1200 with the magnetic core 1100a, the primary wiring 1300 can pass out of the first opening 1122a and out of the third opening 1124, to provide more manners for mounting the winding body 1200 and the magnetic core 1100a, and to provide a quick assembly of the winding body 1200 and the magnetic core 1100a.

The shape of the groove 1121 and the shape of the winding body 1200 may be a ring and matched with each other. Specifically, in a case that the leading-out direction of the primary wiring 1300 and the leading-out direction of the secondary wiring 1400 are perpendicular to each other, the first opening 1122a and the third opening 1124 may be configured for the primary wiring 1300 and the secondary wiring 1400 passing through, respectively; or may be configured for the secondary wiring 1400 and the primary wiring 1300, respectively. Similarly, the second opening 1123 and the third opening 1124 may be configured for the primary wiring 1300 and the secondary wiring 1400 passing through, respectively, or may be configured for the secondary wiring 1400 and the primary wiring 1300, respectively. The winding body 1200 and the magnetic core 1100a are mounted in a more diversified manner, to provide a quick assembly of the winding body 1200 and the magnetic core 1100a.

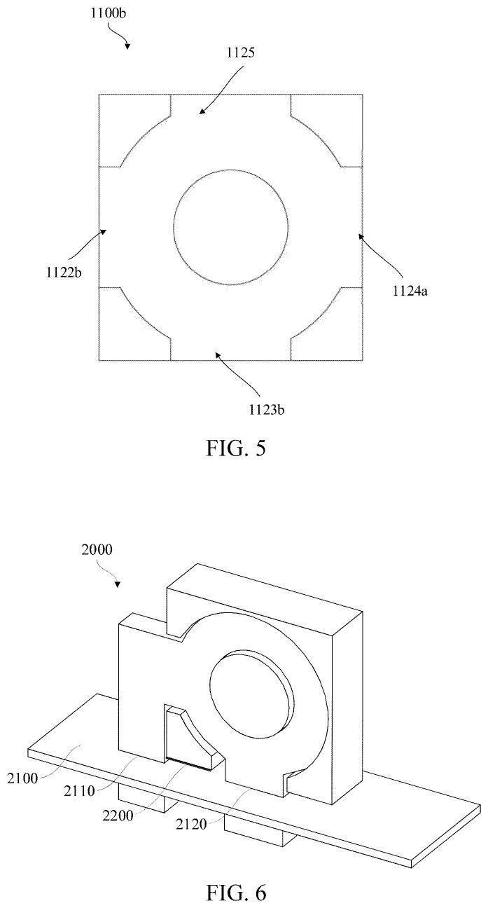

As shown in FIG. 5, the side wall of the groove 1121 is provided with a fourth opening 1125, and the winding body 1200 includes a fourth side. The fourth side is provided opposite to the second side 1203, the fourth opening 1125 is provided corresponding to the fourth side, and the fourth opening 1125 communicates with the groove 1121. By increasing the fourth opening 1125, the heat dissipation area of the winding body 1200 is increased. Since the fourth side of the winding body 1200 is disposed opposite to the second side 1203, the secondary wiring 1400 can also be mounted to the fourth opening 1125. In this case, since the side wall of the groove 1121 is provided with four openings, more mounting manners for the winding body 1200 and the magnetic core 1100 are provided while increasing the heat dissipation area of the winding body 1200, thereby providing a quick assembly of the winding body 1200 and the magnetic core 1100.

Since the primary wiring 1300 can pass through the first opening 1122b or through the second opening 1123b, and the secondary wiring 1400 can pass through the third opening 1124a or through the fourth opening 1125, the winding body 1200 and the magnetic core 1100 have four mounting manners.

In some embodiments, the shape of the groove 1121 and the shape of the winding body 1200 may be a ring and matched with each other. Meanwhile, any adjacent openings of the first opening 1122b, the second opening 1123b, the third opening 1124a, and the fourth opening 1125 may be configured for the primary wiring 1300 and the secondary wiring 1400 passing through. In this case, any opening of the adjacent openings may be configured for the primary wiring 1300 or the secondary wiring 1400 passing through, and the remaining two openings may serve as the main heat dissipation openings to realize heat dissipation of the winding body 1200.

In some embodiments, more than four openings may be provided in the side wall of the groove 1121 according to the requirements for heat dissipation, which is not limited herein.

In some embodiments, the outer frame 1120 includes a spacer 1126 disposed between the first opening 1122 and the second opening 1123 of the outer frame 1120 and outside the winding body 1200. A first insulating member 1500 is disposed between the spacer 1126 and the primary wiring 1300. By providing the first insulating member 1500, the creepage distance between the primary wiring 1300 and the secondary winding 1220 and the creepage distance between the primary wiring 1300 the secondary wiring 1400 are increased.

The first insulating member 1500 is provided between a side of the primary wiring 1300 close to the third side 1202 of the winding body 1200 and the primary wiring 1300.

In some embodiments, the first insulating member 1500 may be held by the primary wiring 1300 and the spacer 1126; alternatively, the first insulating member 1500 may be adhered to a side surface of the primary wiring 1300 close to the third side 1202 of the winding body 1200; alternatively, the first insulating member 1500 may be adhered to a side surface of the spacer 1126 close to the first side 1201 of the winding body 1200. It should be understood that the thickness of the first insulating member 1500 may be determined by the operating voltage difference between the primary wiring 1300 and the secondary wiring 1400.

In some embodiments, the wiring shape of the primary wiring 1300 may be an inverted “L”, and in which case the first insulating member 1500 may be an inverted “L” matching the wiring shape of the primary wiring 1300, to increase the creepage distance between the primary wiring 1300 and the secondary winding 1220 and the creepage distance between the primary wiring 1300 the secondary wiring 1400.

In some embodiments, a second insulating member 1600 is provided between the spacer 1126 and the secondary wiring 1400. By providing the second insulating member 1600, the creepage distance between the secondary wiring 1400 and the primary wiring 1300 can be increased.

In some embodiments, the second insulating member 1600 may be held by the secondary wiring 1400 and the spacer portion 1126.

In some embodiments, the second insulating member 1600 may be adhered to a side surface of the secondary wiring 1400 close to the first side 1201 of the winding body 1200.

In another embodiment, the second insulating 1600 may be adhered to a side surface of the spacer 1126 close to the third side 1202 of the winding body 1200.

Specifically, the second insulating member 1600 and the first insulating member 1500 may be provided at the same time to increase the creepage distance between the secondary wiring 1400 and the primary wiring 1300.

Embodiments of the present disclosure further provide a planar transform device 2000, which includes a planar transform component 1000. The structure of the planar transform component 1000 is described with reference to the above-described embodiments. Since the planar transform component 1000 employs all the technical solutions of the above-described embodiments, the planar transform component 1000 has at least all the beneficial effects of the technical solutions of the above-described embodiments, which is not described herein.

The planar transform may be a power adapter for a notebook computer, a mobile phone, and other handheld electronic devices. The planar transform component 1000 of the planar transform device 2000 of the present disclosure has a relatively simple manufacturing process, and has no limitation on the thickness of the copper on the surface of the coil. At the same time, the length of the lines connecting the wiring and the rectifying device on the circuit board is minimized, thereby minimizing the alternating current loss and the leakage inductance loss.

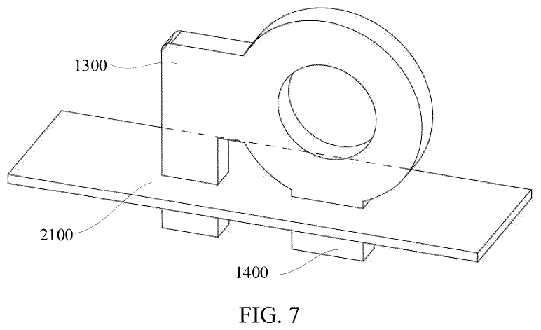

As shown in FIG. 6 and FIG. 7, the planar transform 2000 includes:
the circuit board 2100 and the planar transform component 1000 in any of the above embodiments; where the primary wiring 1300 and the secondary wiring 1400 of the planar transform component 1000 are electrically connected to the circuit board 2100, respectively, and the second side 1203 of the winding body 1200 faces the circuit board 2100. By providing the second side 1203 of the winding body 1200 to face the circuit board 2100, the planar transform component 1000 can be vertically mounted on the circuit board 2100, thereby saving the space on the circuit board 2100 and improving the utilization rate of the space on the circuit board 2100.

A rectifying device is provided on the circuit board 2100, and the rectifying device is electrically connected to the secondary wiring 1400 through a circuit on the circuit board 2100. In order to reduce the connection distance between the secondary winding 1220 and the rectifying member, the rectifying member may be close to the connection point between the secondary wiring 1400 and the circuit board 2100.

In some embodiments, the circuit board 2100 includes a first connecting portion 2110 and a second connecting portion 2120, the primary wiring 1300 is electrically connected to the first connecting portion 2110, the secondary wiring 1400 is electrically connected to the second connecting portion 2120, and a creepage distance is predetermined between the first connecting portion 2110 and the second connecting portion 2120.

The creepage distance may be predetermined according to the voltage difference between the primary wiring 1300 and the secondary wiring 1400.

In some embodiments, a first limiting groove is provided in the first connecting portion 2110, and a second limiting groove is provided in the second connecting portion 2120. The primary wiring 1300 is inserted into the first limiting groove and abuts against the inner walls of the first limiting groove, and the secondary wiring 1400 is inserted into the second limiting groove and abuts against the inner walls of the second limiting groove.

In some embodiments, electrical connections between the planar transform component and the circuit board 2100 include, but are not limited to, direct contact electrical connections and electrical connections by metal soldering.

In some embodiments, the secondary wiring 1400 extends along in a direction from the winding body 1200 toward the circuit board 2100, to shorten the extension distance of the secondary wiring 1400, and reduce the alternating current loss and the leakage inductance loss.

In a case that the secondary wiring 1400 extends along in a direction from the winding body 1200 toward the circuit board 2100, it is necessary to consider the creepage distance between the primary wiring 1300 and the secondary wiring 1400.

In some embodiments, to minimize the extension distance of the secondary wiring 1400, the extension direction of the secondary wiring 1400 may be perpendicular to the circuit board 2100.

In some embodiments, in a case that the secondary wiring 1400 extends along in a direction from the winding body 1200 toward the circuit board 2100, the connection between the secondary wiring 1400 and the circuit board 2100 may be away from the first side 1201.

In some embodiments, the creepage distance predetermined between the first connecting portion 2110 and the second connecting portion 2120 includes providing a third insulating member 2200 between the spacer 1126 of the outer frame 1120 in the planar transform component 1000 and the circuit board 2100 to increase the creepage distance between the first connecting portion 2110 and the second connecting portion 2120. By providing the third insulating member 2200 to increase the creepage distance between the first connecting portion 2110 and the second connecting portion 2120, it is ensured that no electric leakage or the like occurs when the planar transform 2000 operates.

In some embodiments, the third insulating member 2200 may be simultaneously abutted by the spacer 1126 and the circuit board 2100 from two opposite directions.

In another embodiment, the third insulating member 2200 may surround the circuit board 2100 along the circumference of the circuit board 2100 to increase the creepage distance between the first connecting portion 2110 and the second connecting portion 2120.

In yet another embodiment, the third insulating 2200 may be adhered to the circuit board 2100 to increase the creepage distance between the first connecting portion 2110 and the second connecting portion 2120.

The foregoing describes in detail a planar transform component and a planar transform device according to embodiments of the present disclosure. Specific examples are used herein to illustrate the principles and embodiments of the present disclosure. The description of the above embodiments is merely provided to assist in understanding the technical solution of the present disclosure and the core concepts thereof. It should be understood by those of ordinary skill in the art that modifications may still be made to the technical solutions described in the foregoing embodiments, or equivalents may be made to some of the technical features therein. These modifications or equivalents do not depart the essence of the corresponding technical solutions from the scope of the technical solutions of the embodiments of the present disclosure.

1. A planar transform component, comprising:
a winding body, wherein the winding body comprises a primary winding and a secondary winding stacked, wherein a first side, a second side, and a third side are provided along a circumference of the winding body, and the first side and the third side are oppositely disposed;
a primary wiring, wherein the primary wiring is electrically connected to the primary winding, and the primary wiring is led out from the first side of the winding body; and
a secondary wiring, wherein the secondary wiring is electrically connected to the secondary winding, the secondary wiring is led out from the second side of the winding body, and an extension direction of the secondary wiring is provided at an included angle with a direction from the first side to the third side.

2. The planar transform component of claim 1, wherein the included angle defined by the extension direction of the secondary wiring and the direction from the first side to the third side ranges from 0° to 180°.

3. The planar transform component of claim 1, wherein the winding body is a multi-layer structure of a plurality of PCB boards.

4. The planar transform component of claim 3, wherein the plurality of PCB boards is stacked in a stacking direction of the primary winding and the secondary winding.

5. The planar transform component of claim 3, wherein PCB boards of the plurality of PCB boards in the primary winding are disposed adjacent to each other, and PCB boards of the plurality of PCB boards in the secondary winding are disposed adjacent to each other.

6. The planar transform component of claim 3, wherein PCB boards of the plurality of PCB boards in the primary winding and PCB boards of the plurality of PCB boards in the secondary winding are alternatively stacked with each other.

7. The planar transform component of claim 3, wherein PCB boards of the plurality of PCB boards in the primary winding are provided in a middle of the winding body, and PCB boards of the plurality of PCB boards in the secondary winding are stacked on opposite sides of the primary winding in a first direction.

8. The planar transform component of claim 1, wherein the secondary wiring comprises a first secondary sub-wiring and a second secondary sub-wiring; the first secondary sub-wiring and the second secondary sub-wiring are led out from the second side of the winding body, respectively; the first secondary sub-wiring and the second secondary sub-wiring are electrically connected to both ends of the secondary winding, respectively; an extension direction of the first secondary sub-wiring is provided at an included angle with the direction from the first side to the third side, and an extension direction of the second secondary sub-wiring is provided at an included angle with the direction from the first side to the third side.

9. The planar transform component of claim 8, wherein the extension direction of the first secondary sub-wiring and the extension direction of the second secondary sub-wiring are arranged in parallel; and the first secondary sub-wiring and the second secondary sub-wiring partially overlap in a stacking direction of the primary winding and the secondary winding.

10. The planar transform component of claim 9, wherein the first secondary sub-wiring and the second secondary sub-wiring completely overlap in the stacking direction of the primary winding and the secondary winding.

11. The planar transform component of claim 1, wherein:
the planar transform component comprises a magnetic core having a magnetic column, the primary winding and the secondary winding are wound around the magnetic column, respectively;
the magnetic core further comprises an outer frame around the winding body, a groove for receiving the winding body is defined in the outer frame, and the magnetic column is connected to the outer frame and positioned in the groove; and
a first opening and a second opening are provided on a side wall of the groove of the outer frame, the first opening is provided corresponding to the first side of the winding body for the primary wiring passing through, the second opening is provided corresponding to the second side of the winding body for the secondary wiring passing through, and the first opening and the second opening are respectively communicated with the groove.

12. The planar transform component of claim 11, wherein a third opening is provided on the side wall of the groove, and the third opening communicates with the groove.

13. The planar transform component of claim 12, wherein a plurality of third openings is provided on the side wall of the groove.

14. The planar transform component of claim 12, wherein a fourth opening is provided on the side wall of the groove, the winding body comprises a fourth side, the fourth side is provided opposite to the second side, the fourth opening is provided corresponding to the fourth side, and the fourth opening communicates with the groove.

15. The planar transform component of claim 11, wherein the outer frame comprises a spacer between the first opening and the second opening of the outer frame, the spacer is disposed outside the winding body, and a first insulating member is provided between the spacer and the primary wiring.

16. The planar transform component of claim 11, wherein the outer frame comprises a spacer between the first opening and the second opening of the outer frame, the spacer is disposed outside the winding body, and a second insulating member is provided between the spacer and the secondary wiring.

17. A planar transform device, wherein the planar transform device comprises:
a circuit board; and
the planar transform component of claim 1, wherein the primary wiring and secondary wiring of the planar transform component are electrically connected to the circuit board, respectively, and the second side of the winding body faces the circuit board.

18. The planar transform device of claim 17, wherein the circuit board comprises a first connecting portion and a second connecting portion, the primary wiring is electrically connected to the first connecting portion, the secondary wiring is electrically connected to the second connecting portion, and a creepage distance predetermined between the first connecting portion and the second connecting portion.

19. The planar transform device of claim 17, wherein the secondary wiring extends along a direction from the winding body toward the circuit board.

20. The planar transform device of claim 18, wherein the creepage distance predetermined between the first connecting portion and the second connecting portion is obtained by providing a third insulating member between the spacer of the outer frame of the planar transform component and the circuit board to increase a creepage distance between the first connecting portion and the second connecting portion.
